(19) United States
(12) Patent Application Publication
(10) Pub. No.: US 2022/0275487 A1
(43) Pub. Date: Sep. 1, 2022

(54) GRAIN-ORIENTED ELECTRICAL STEEL SHEET

(71) Applicant: JFE Steel Corporation, Tokyo (JP)

(72) Inventors: Yoshihisa Ichihara, Chiyoda-ku, Tokyo (JP); Takeshi Omura, Chiyoda-ku, Tokyo (JP); Hirotaka Inoue, Chiyoda-ku, Tokyo (JP); Shigehiro Takajo, Chiyoda-ku, Tokyo (JP); Masanori Odachi, Chiyoda-ku, Tokyo (JP); Kunihiro Senda, Chiyoda-ku, Tokyo (JP)

(73) Assignee: JFE Steel Corporation, Tokyo (JP)

(21) Appl. No.: 17/629,863

(22) PCT Filed: Jul. 3, 2020
(86) PCT No.: PCT/JP2020/026181

§ 371 Date: Jan. 25, 2022

(30) Foreign Application Priority Data
Jul. 31, 2019 (JP) 2019-140966

(51) Int. Cl. C22C 38/00; C21D 9/46

(52) U.S. Cl. CPC C22C 38/00; C21D 9/46; C21D 2201/05

(57) ABSTRACT

A grain-oriented electrical steel sheet having linear grooves formed cyclically in a rolling direction of the grain-oriented electrical steel sheet such that a longitudinal direction of the linear grooves intersects the rolling direction, in which each of the linear grooves has a discontinuous portion of center lines where center lines of the groove are shifted in a groove width direction, and when a width of the linear groove is defined as a and a distance in the groove width direction between the center lines in the discontinuous portion of center lines is defined as b, a and b satisfy relational expression (1) below.

0.05≤b/a≤0.95 (1)

### CROSS REFERENCE TO RELATED APPLICATIONS

This is the U.S. National Phase application of PCT/JP2020/026181 filed Jul. 3, 2020 which claims priority to Japanese Patent Application No. 2019-140966, filed Jul. 31, 2019, the disclosures of these applications being incorporated herein by reference in their entireties for all purposes.

### FIELD OF THE INVENTION

The present invention relates to a grain-oriented electrical steel sheet and, in particular, a grain-oriented electrical steel sheet that can preferably be used as a material for an iron core for a transformer and the like.

### BACKGROUND OF THE INVENTION

A grain-oriented electrical steel sheet is used as an iron core material for a transformer. The energy loss of a transformer is strongly affected by the iron loss of a grain-oriented electrical steel sheet. Nowadays, there is a strong demand for decreasing the energy loss of a transformer from the viewpoint of energy saving and environmental regulations. Since the iron loss of a transformer is affected by the iron loss of a grain-oriented electrical steel sheet, which is a material for the transformer, developing a grain-oriented electrical steel sheet having low iron loss is very important.

The iron loss of a grain-oriented electrical steel sheet is divided into hysteresis loss and eddy-current loss. Examples of a method developed for improving hysteresis loss include a method in which the (110) [001] orientation, which is called GOSS orientation, is highly oriented in the rolling direction and a method in which the amounts of impurities contained in a steel sheet are decreased. On the other hand, examples of a method developed for improving eddy-current loss include a method in which electrical resistance is increased by adding Si and a method in which film tension is applied in the rolling direction. However, these methods are of limited effectiveness for further decreasing iron loss in a manufacturing process.

Therefore, a magnetic domain refining technique has been developed which provides the density non-uniformity of magnetic flux by using a physical method such as a method in which grooves are formed or local strain is applied after a steel sheet has been subjected to finish annealing followed by baking of an insulation coating film. This technique is a method in which iron loss and, in particular, eddy-current loss are decreased by segmentalizing the width of a 180° magnetic domain (main magnetic domain), which is formed in the rolling direction.

A type of such a magnetic domain refining technique in which there is no decrease in the effect of the technique even after the product sheet has been subjected to stress-relief annealing, is particularly called a heat-resistant magnetic domain refining method. Such a method is generally used for a material for a wound iron core, which is indispensably subjected to stress-relief annealing in a manufacturing process. For example, Patent Literature 1 proposes a technique in which iron loss, which is originally 0.80 W/kg or more in terms of W_{17/50}, is decreased to 0.70 W/kg or less after linear grooves having a width of 300 μm or less and a depth of 100 μm or less were formed on a steel sheet surface.

Examples of a method proposed for forming grooves on a grain-oriented electrical steel sheet include an electroetching method (Patent Literature 2), in which grooves are formed on the steel sheet surface by performing electroetching, a laser method (Patent Literature 3), in which the steel sheet is locally melted and evaporated by using a high-power laser, and a gear pressing method (Patent Literature 4), in which indentations are produced by pressing a gear-shaped roll onto the steel sheet.

### Patent Literature

PTL 1: Japanese Examined Patent Application Publication No. 6-22179

PTL 2: Japanese Unexamined Patent Application Publication No. 2012-77380

PTL 3: Japanese Unexamined Patent Application Publication No. 2003-129135

PTL 4: Japanese Unexamined Patent Application Publication No. 62-86121

PTL 5: International Publication No. WO2016/171129

### SUMMARY OF THE INVENTION

Generally, it is known that the effect of magnetic domain refining due to grooves increases with an increase in the surface area of the groove side walls of the steel sheet. However, in the case that there is an increase in the depth of the grooves in the sheet thickness direction, the groove volume increases and the magnetic properties of the steel sheet such as a magnetic permeability deteriorates. Further, there is an increase in disadvantages in a production process such as breakage occurring when the steel sheet passes through a production line. Therefore, in the case of a material in the related art with magnetic domains refined by using grooves, consideration is given to increasing the effect of improving iron loss by optimizing a groove forming pattern. For example, Patent Literature 5 proposes a method in which plural linear groove groups are formed on a steel sheet surface and linear grooves adjacent to each other in the linear groove forming direction are arranged such that the edges thereof are separated with each other or such that the grooves overlap each other on a projection plane in a direction perpendicular to the rolling direction.

However, in the case of the method described above, when the linear grooves adjacent to each other are arranged such that the grooves overlap each other on a projection plane in a direction perpendicular to the rolling direction, although it is possible to realize an increased effect of magnetic domain refining, the magnetic permeability decreases since the total volume of the grooves increases. In addition, when the edges of linear grooves are separated with each other, although it is possible to suppress a deterioration in magnetic properties due to a deterioration in magnetic permeability, there is a problem of an insufficient effect of magnetic domain refining.

Therefore, to develop a higher-performance material with heat-resistant refined magnetic domains, a groove forming pattern for realizing not only a large effect of magnetic domain refining but also high magnetic flux density is necessary.

Aspects of the present invention have been completed in view of the situation described above, and an object according to aspects of the present invention is to provide a grain-oriented electrical steel sheet on which linear grooves are formed and with which it is possible to realize not only an excellent effect of decreasing iron loss but also a high magnetic flux density.

The present inventors diligently conducted investigations to solve the problems described above.

First, investigations regarding the shape of grooves formed on the surface of a steel sheet were conducted. As described above, when grooves are formed on a steel sheet, there is a deterioration in magnetic permeability. Since the degree of such a deterioration in magnetic permeability correlates with the volume of grooves, it is preferable that the volume of formed grooves be as small as possible. Therefore, regarding the shape of grooves formed on a steel sheet, it is considered that a case that grooves are formed such that each groove is formed continuously in the sheet transverse direction, that is, without discontinuity in the sheet transverse direction, is most preferable. On the other hand, the effect of decreasing iron loss due to the grooves formed in such a manner is less than that in the case that small-scale groove groups in which the grooves are not formed continuously in the sheet transverse direction are formed such that edges of grooves adjacent to each other overlap each other on a projection plane in a direction perpendicular to the rolling direction. This is because the effect of magnetic domain refining increases with an increase in the discontinuous portions of magnetization, that is, the surface area of grooves.

Therefore, the present inventors diligently conducted additional investigations regarding a method for further improving iron loss even in the case of grooves formed in a straight line (continuously) by improving the shape of the grooves. Here, a grain-oriented electrical steel sheet on which grooves were formed is subjected to final annealing after an annealing separator is coated to the grooved steel sheet. This final annealing is performed for the purpose of the secondary recrystallization of the steel sheet and for forming a forsterite coating film. Simultaneous, a forsterite coating film is also formed at the bottom of the groove. In addition, it is known that, in the case that such a forsterite coating film is densely formed, there is an improvement in iron loss due to an increase in film tension. That is, it was considered that it may be possible to further improve the iron loss by forming a dense forsterite coating film at the bottom of the groove.

Therefore, additional investigations were conducted regarding a method for forming a dense forsterite coating film at the bottom of the groove. As a result, it was found that there is a marked improvement in the iron loss in the case that, when linear grooves are formed cyclically in the rolling direction of a steel sheet such that the longitudinal direction thereof is a direction intersecting the rolling direction of the steel sheet as illustrated in FIG. 1(a), such that:

(1) each of the linear grooves formed in the direction intersecting the rolling direction of the steel sheet has at least one region (a discontinuous portion 2 of center lines) in which, as illustrated in FIG. 1 (b), a shift in the width direction of the linear groove 1 is provided between the positions of center lines P passing through the central positions of the width a of the linear groove 1, and
(2) when the width of the linear groove 1 is defined as a and the distance in the width direction of the linear groove 1 between the center lines in the discontinuous portion 2 of center lines is defined as b, a and b satisfy relational expression (1) below.

0.05≤b/a≤0.95 (1)

Here, in more detail, the expression “discontinuous portion 2 of center lines” described above denotes a region in which the center lines P (the lines passing through the central positions of the width a of the linear groove 1 and are parallel to the longitudinal direction of the linear groove 1 (formation direction of the linear groove 1)) are parallel to each other and non-collinear (a region in which parallel center lines exist).

Moreover, the present inventors conducted detailed investigations and, as a result, found that, even in the case that relational expression (1) above is satisfied, the effect of improving iron loss reverses the upward trend when the length c in the longitudinal direction of the linear groove of the above-described discontinuous portion 2 of center lines (that is, the length in the longitudinal direction of the linear groove of the region in which the center lines P are non-collinear, hereinafter, also referred to as “lap length”) is more than 50 mm.

Aspects of the present invention have been completed on the basis of the knowledge described above. That is, the subject matter of aspects of the present invention is as follows.

[1] A grain-oriented electrical steel sheet having linear grooves formed cyclically in a rolling direction of the grain-oriented electrical steel sheet such that a longitudinal direction of the linear grooves intersects the rolling direction, in which:

each of the linear grooves has a discontinuous portion of center lines where center lines of the groove are shifted in a groove width direction, and

when a width of the linear groove is defined as a and a distance in the groove width direction between the center lines in the discontinuous portion of center lines is defined as b,

a and b satisfy relational expression (1) below.

0.05≤b/a≤0.95 (1)

[2] The grain-oriented electrical steel sheet according to item [1], in which a length in the longitudinal direction of the linear groove of the discontinuous portion of center lines is 0 mm or more and 50 mm or less.

According to aspects of the present invention, it is possible to provide a grain-oriented electrical steel sheet having linear grooves which is possible to realize not only an excellent effect of decreasing iron loss but also a high magnetic flux density.

According to aspects of the present invention, it is possible to obtain a grain-oriented electrical steel sheet having linear grooves and heat-resistant refined magnetic domains that is possible to obtain a larger effect of decreasing iron loss while suppressing a deterioration in magnetic flux density better than ever.

### BRIEF DESCRIPTION OF THE DRAWINGS

FIG. 1(a) is a diagram illustrating the shape of a linear groove formed in a direction intersecting the rolling direction of a grain-oriented electrical steel sheet, and FIG. 1(b) is a diagram illustrating the shape of a linear groove having a discontinuous portion of center lines.

FIG. 2 is a graph illustrating the relationship between b/a in a discontinuous portion of center lines and iron loss.

FIG. 3 is a graph illustrating the relationship between a lap length c in a discontinuous portion of center lines and iron loss.

FIG. 4 is a diagram illustrating one example of a resist pattern formed in EXAMPLES.

### DETAILED DESCRIPTION OF EMBODIMENTS OF THE INVENTION

First, experimental results which have led to the completion of aspects of the present invention will be described.

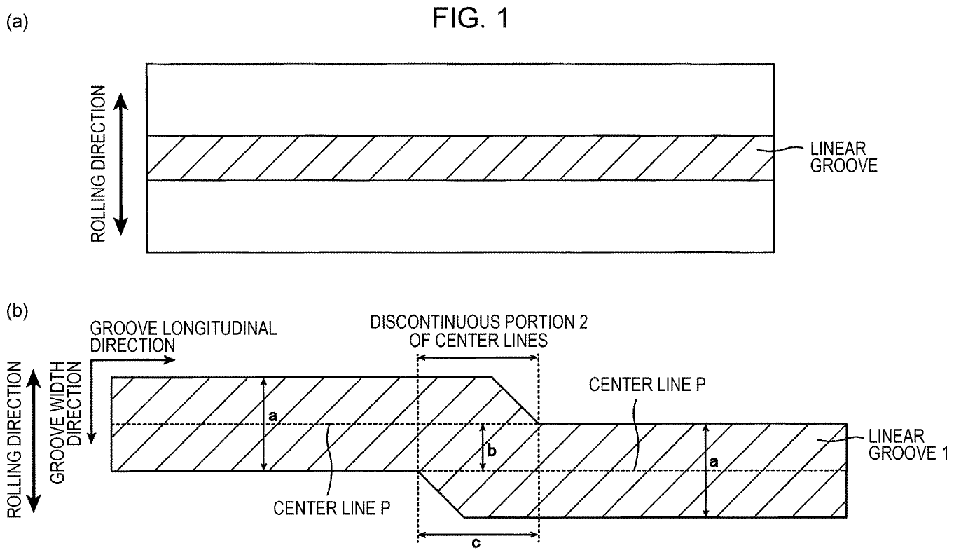

Linear grooves whose longitudinal direction was a direction intersecting the rolling direction of a grain-oriented electrical steel sheet (cold rolled steel strip) and each of which has a discontinuous portion of center lines were formed on the grain-oriented electrical steel sheet. At this time, decarburization annealing was performed on samples on which grooves had been formed such that the ratio of a distance b in the groove width direction provided between center lines with respect to the groove width a varied variously (refer to FIG. 1(b)). Thereafter, the samples were coated with annealing separators, wounded into coils, and final annealing were performed. Subsequently, having performed flattening annealing and formed tension coatings on the surfaces of the steel sheets to obtain final products, the magnetic properties of the final products were investigated. At this time, each of the groove width a, the length (lap length c) in the longitudinal direction of the linear groove of the discontinuous portion of center lines, and the depth of the groove (the depth in the sheet thickness direction of the formed groove) was set to have a constant value. For the evaluation of the magnetic properties, iron loss W_{17/50} and magnetic flux density B₈ were used. The expression “W_{17/50}” denotes iron loss when alternating magnetization of 1.7 T and 50 Hz is performed in the rolling direction of the steel sheet, and the expression “B₈” denotes magnetic flux density when magnetization is performed in the rolling direction with a magnetizing force of 800 A/m.

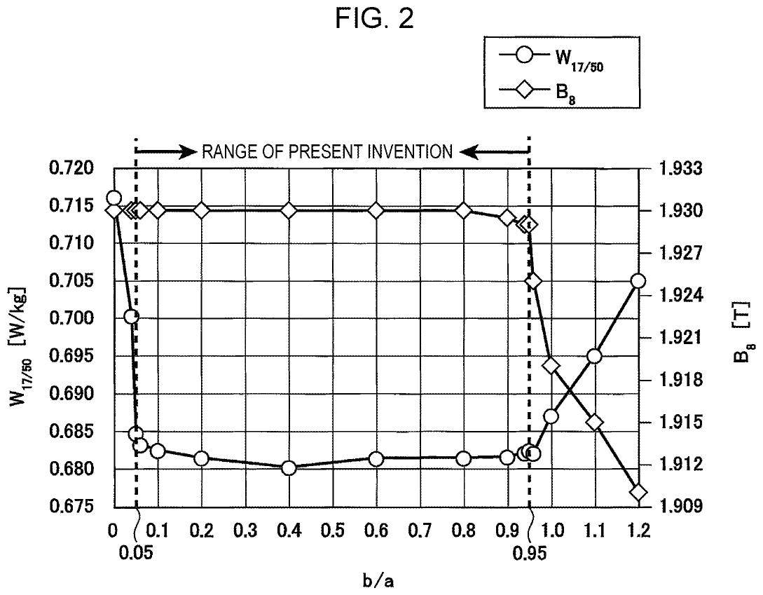

The results are given in FIG. 2. It was clarified that there was a large effect of improving iron loss (W_{17/50}) in the case that b/a was 0.05 or more. This is considered to be because, when final annealing was performed after the sample was wound into a coil, since an atmosphere gas in the final annealing, which flowed along the linear grooves formed continuously in the strip transverse direction, is stagnated in the discontinuous portion of center lines, a reaction for forming a forsterite coating film was promoted. As a result, a dense microstructure is formed. In addition, in the case that b/a was 1 or more, that is, the groove did not have a continuous straight-line shape, there was a significant decrease in the effect of improving iron loss. This is considered to be because, since the grooves did not have continuous straight-line shapes in the sheet transverse direction due to the groove break, the flow of the atmosphere gas was blocked. As a result, the effect described above has not been realized.

On the other hand, it was clarified that there was a tendency that magnetic flux density (B₈) deteriorated in the case that b/a was more than 0.95. This is considered to be because, since there was an increase in the groove volume due to an increase in the distance b in the groove width direction between center lines, there was a decrease in the magnetic permeability of the steel sheet. From the results described above, the appropriate range of b/a is set to be 0.05 or more and 0.95 or less. It is more preferable that b/a is 0.10 or more. In addition, it is more preferable that b/a is 0.90 or less.

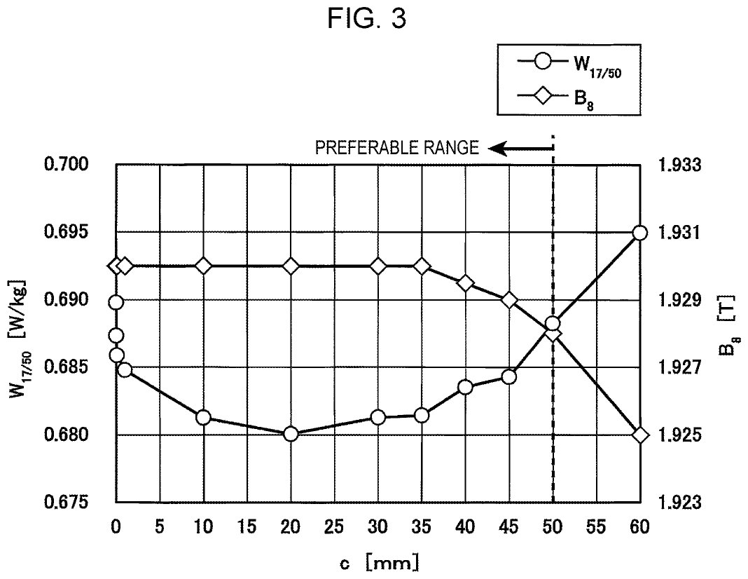

Subsequently, while each of the groove width a, the distance b in the groove width direction between center lines, and the groove depth of the samples was set to have a constant value, final product steel strip having grooves having various lap lengths c were prepared by performing the same processes as described above, and magnetic properties were investigated. The results are given in FIG. 3. It was clarified that, in the case that the lap length c was 50 mm or less, there was a large effect of improving iron loss. This is considered to be because, as in the case described above, a dense forsterite coating film was formed due to atmosphere gas stagnation in a discontinuous portion of center lines. On the other hand, it was clarified that, in the case that the lap length c is more than 50 mm, there was a decrease in the effect of improving iron loss. This is considered to be because, since there was an improvement in the flowability of the atmosphere gas in the groove due to an increase in the lap length, it was difficult to form a dense forsterite coating film.

Moreover, it was also clarified that, in the case that the lap length c is more than 50 mm, there was a deterioration in B₈. This is considered to be because there was an increase in the volume of the groove due to an increase in lap length c. In addition, from the viewpoint of forming a linear groove, it is necessary that the lap length c of the discontinuous portion of center lines is 0 mm or more. From the results described above, the preferable range of the lap length c is set to be 0 mm or more and 50 mm or less. It is more preferable that the lap length c is 0.1 mm or more. In addition, it is more preferable that the lap length c is 40 mm or less.

Hereafter, preferable embodiments of the present invention will be described in detail. However, the present invention is not limited to the constitutions disclosed in the embodiments, and aspects of the present invention may be performed by making various alterations within a range in accordance with the intent of the present invention.

### Grain-Oriented Electrical Steel Sheet

The basic constituents, inhibitor constituents, and optional constituents of the steel material (slab) for the grain-oriented electrical steel sheet to which aspects of the present invention are applied will be described in detail.

### Basic Constituents

C: 0.08 mass % or less

Although C is added to improve the microstructure of a hot rolled steel sheet, in the case that the C content is more than 0.08 mass %, it is difficult to decrease the C content through decarburization to a C content of 50 mass ppm or less, with which magnetic aging does not occur in manufacturing processes. Therefore, it is preferable that the C content is 0.08 mass % or less. In addition, since secondary recrystallization occurs even in a steel material which does not contain C, there is no particular limitation on the lower limit of the C content.

Si: 2.0 mass % to 8.0 mass %

Si is an element effective for improving iron loss by increasing the electrical resistance of steel. However, in the case that the Si content is less than 2.0 mass %, it is not possible to sufficiently realize such an effect of improvement. On the other hand, in the case that the Si content is more than 8.0 mass %, there is a marked deterioration in workability and sheet passage, and there is a decrease in magnetic flux density. Therefore, it is preferable that the Si content is 2.0 mass % to 8.0 mass %.

Mn: 0.005 mass % to 1.0 mass %.

Mn is an element necessary to improve hot workability. However, in the case that the Mn content is less than 0.005 mass %, it is not possible to sufficiently realize such an effect. On the other hand, in the case that the Mn content is more than 1.0 mass %, there is a deterioration in magnetic flux density. Therefore, it is preferable that the Mn content is 0.005 mass % to 1.0 mass %.

### Inhibitor Constituents

In accordance with aspects of the present invention, it is sufficient that a slab for a grain-oriented electrical steel sheet have a chemical composition with which secondary recrystallization occurs. In the case that an inhibitor is used to allow secondary recrystallization to occur, for example, it is sufficient that Al and N are appropriately added when an AlN-based inhibitor is used and that Mn and Se and/or S are appropriately added when a MnS-MnSe-based inhibitor is used. It is needless to say that both kinds of inhibitors may be used. In this case, the preferable content of each of Al, N, S, and Se is as follows.

Al: 0.010 mass % to 0.065 mass %
N: 0.0050 mass % to 0.0120 mass %
S: 0.005 mass % to 0.030 mass %
Se: 0.005 mass % to 0.030 mass %

Moreover, aspects of the present invention may be applied to a grain-oriented electrical steel sheet which does not use an inhibitor in which the content of Al, N, S, or Se is limited. In this case, it is preferable that the content of each of Al, N, S, and Se is limited as follows.

Al: 0.010 mass % or less
N: 0.0050 mass % or less
S: 0.0050 mass % or less
Se: 0.0050 mass % or less

In addition to the basic constituents and the inhibitor constituents, the optional constituents described below, which are known to be effective for improving magnetic properties, may be appropriately added.

One or more selected from Ni: 0.03 mass % to 1.50 mass %,
Sn: 0.01 mass % to 1.50 mass %,
Sb: 0.005 mass % to 1.50 mass %,
Cu: 0.03 mass % to 3.0 mass %,
P: 0.03 mass % to 0.50 mass %,
Mo: 0.005 mass % to 0.10 mass %, and
Cr: 0.03 mass % to 1.50 mass %

Ni is an element effective for improving magnetic properties by improving the microstructure of a hot rolled steel sheet. However, in the case that the Ni content is less than 0.03 mass %, contribution to an improvement in magnetic properties is small. On the other hand, in the case that the Ni content is more than 1.50 mass %, since secondary recrystallization is unstable, there is a deterioration in magnetic properties. Therefore, it is preferable that the Ni content is 0.03 mass % to 1.50 mass %.

In addition, Sn, Sb, Cu, P, Mo, and Cr are also elements that improve magnetic properties. However, in the case that the content of each of such elements is less than the corresponding lower limit described above, such an effect is insufficient. In addition, in the case that the content of each of such elements is more than the corresponding upper limit described above, since grain growth in secondary recrystallization is suppressed, there is a deterioration in magnetic properties. Therefore, it is preferable that the content of each of such elements is within the range described above.

In addition, the remainder which is different from the constituents described above is Fe and incidental impurities. Here, in a product steel sheet, the contents of the basic constituents and the optional constituents other than C in a steel material (slab) are maintained. On the other hand, there is a decrease in the C content due to decarburization annealing. In addition, since there is a decrease in the contents of the inhibitor constituents in final annealing described below, the contents of the inhibitor constituents in a product steel sheet are at a level of incidental impurities.

After having performed hot rolling on a steel material (slab) for a grain-oriented electrical steel sheet having the chemical composition described above, hot-rolled-sheet annealing is performed. Subsequently, cold rolling is performed once, optionally twice or more with intermediate annealing between periods in which cold rolling is performed, to obtain a steel strip having the final thickness. Subsequently, after having performed decarburization annealing on the steel strip, an annealing separator containing mainly MgO is coated to the annealed steel strip, and the steel strip is wound into a coil. Thereafter, final annealing is performed for the purpose of the secondary recrystallization and the formation of a forsterite coating film. After having performed flattening annealing on the steel strip which had been subjected to final annealing, for example, a magnesium phosphate-based tension coating is formed to obtain a product steel strip.

In accordance with aspects of the present invention, in an appropriately selected process after cold rolling is performed and before an annealing separator is applied, linear grooves are formed on the surface of a grain-oriented electrical steel sheet (steel strip).

### Groove Formation Method

Exemplary groove formation methods according to aspects of the present invention include a method in which, after having printed a resist pattern so that the discontinuous portion of center lines is formed by using a gravure printing method or an ink-jet printing method, electroetching is performed on non-printed portions to form grooves. Exemplary methods according to aspects of the present invention also includes a method in which, after having coating a resist ink across the whole surface of a steel sheet to form a coated resist and performed patterning (resist removal) through laser irradiation so that the discontinuous portion of center lines is formed, electroetching is performed on the exposed portions in which the coated resist is removed to form grooves. However, there is no particular limitation on the method.

### Groove Dimensions

Hereafter, preferable groove dimensions according to aspects of the present invention will be described. Here, the meaning of the expression “groove dimensions” includes not only a groove width and a groove depth but also a groove interval between grooves formed cyclically in the rolling direction of a grain-oriented electrical steel sheet (steel strip) and an angle formed by the longitudinal direction of the linear grooves and the sheet transverse direction.

Groove width: 10 to 300 μm

In the case that the groove depth is set to have an almost constant value, since the degree of a deterioration in magnetic permeability increases with an increase in the groove width, it is preferable that the groove width be as small as possible. Therefore, it is preferable that the groove width is 300 μm or less. However, in the case that the groove width is excessively small, since there is a decrease in the effect of improving iron loss due to magnetic pole coupling occurring at both groove ends, it is preferable that the lower limit of the groove width is 10 μm.

Groove depth: 4% to 25% of sheet thickness

The effect of improving iron loss due to forming grooves increases with an increase in the surface area of the side walls of the grooves, that is, an increase in the formed depth of the groove (groove depth). Therefore, it is preferable that a groove having a depth of 4% or more of the sheet thickness is formed. On the other hand, it is needless to say that, an increase in the groove depth increases the groove volume which results in a deterioration in magnetic permeability. Moreover, there is a risk of the groove becoming a starting point at which fracturing occurs at the time of sheet passage. Therefore, it is preferable that the upper limit of the groove depth is 25% of the sheet thickness.

Linear groove forming interval in rolling direction: 1.5 mm to 10 mm

As described above, since the effect of improving iron loss increases with an increase in the surface area of the side walls of grooves, the effect increases with a decrease in the linear groove forming interval in the rolling direction. However, in the case that there is a decrease in the linear groove forming interval, since there is an increase in the volume fraction of grooves with respect to steel sheet volume, there is a deterioration in magnetic permeability. There is also an increased risk of fracturing occurring in operation. Therefore, it is preferable that the linear groove forming interval in the rolling direction is 1.5 mm to 10 mm.

Angle formed by longitudinal direction of linear grooves and sheet transverse direction: within a range of ±30°

In the case that there is an increase in the absolute value of an angle formed by the longitudinal direction of linear grooves and the sheet transverse direction, since there is an increase in the groove volume, there is a tendency of deteriorating the magnetic permeability. Therefore, it is preferable that the angle formed by the longitudinal direction of linear grooves and the sheet transverse direction is within a range of ±30°.

### Method for Measuring Groove Shape

The groove width a in the discontinuous portion of center lines, the distance b in the groove width direction between the center lines, and the lap length c according to aspects of the present invention are determined by measuring the corresponding lengths by performing optical microscopic observation on the surface of a grain-oriented electrical steel sheet on which a tension coating is formed. Regarding the groove depth, by performing observation with a laser microscope on the surface of the above-mentioned grain-oriented electrical steel sheet, a depth profile in the rolling direction of each of the grooves is obtained. The largest depth in each of the obtained depth profiles are taken and the average value thereof is defined as the groove depth.

In accordance with aspects of the present invention, with exception of the processes and manufacturing conditions described above, known methods for manufacturing a grain-oriented electrical steel sheet in which a magnetic domain refining treatment is performed by forming grooves may be appropriately used.

### EXAMPLES

Hereafter, aspects of the present invention will be described in detail in accordance with examples. The examples below are preferable examples of the present invention, and the present invention is not limited to the examples at all. Aspects of the present invention may be performed by appropriately making alterations within a range in accordance with the intent of the present invention, and working examples performed in such a way are all within the technical scope according to aspects of the present invention.

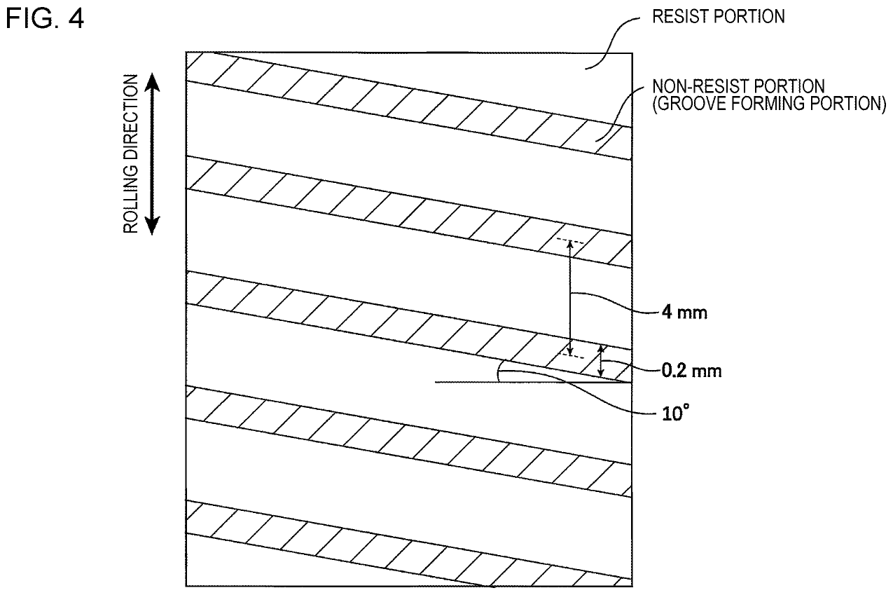

After having performed hot rolling on each of the steel materials (slabs) for grain-oriented electrical steel sheets having the chemical compositions given in Table 1 with Fe and incidental impurities, hot-rolled-sheet annealing was performed. Subsequently, cold rolling was performed twice with intermediate annealing between the periods in which cold rolling was performed to obtain a cold rolled steel strip having a thickness of 0.23 mm. After having printed resist patterns on the obtained cold rolled steel strip by using an ink-jet method, grooves were formed by using an electroetching method. At this time, as illustrated in FIG. 4, resist patterns formed of resist portions and non-resist portions were formed such that the groove width was 200 μm, the groove forming interval in the rolling direction was 4 mm, and the angle formed by the longitudinal direction of the groove and the sheet transverse direction was 10°. While, the distance b in the groove width direction between the center lines in the discontinuous portion of center lines and the lap length c were varied variously. In addition, the electroetching condition was set so that the groove depth was 20 μm. After having stripped the coated resist remaining on the surface of the steel strip, on which the linear grooves had been formed by using an electroetching method, in an alkaline solution, decarburization annealing was performed. Thereafter, an annealing separator containing mainly MgO was coated on the steel strip, and the steel strip was wounded into a coil, a final annealing was performed. After having performed flattening annealing on the steel strip subjected to the final annealing, a magnesium phosphate-based tension coating was formed on the steel strip surface to obtain a final product steel strip.

Samples having an RD length of 280 mm and a TD length of 100 mm were taken from the obtained steel strip such that each linear groove 1 contained one discontinuous portion of center lines, and W_{17/50} and B₈ were determined by using a single sheet test (SST) method. Here, “RD” denotes the rolling direction of the steel sheet, and “TD” denotes the sheet transverse direction. By performing optical microscopic observation on the surface of each of the samples whose magnetic properties had been determined, the groove width a, the distance b in the groove width direction between the center lines in the discontinuous portion of center lines, and the lap length c were determined. Subsequently, section of the discontinuous portion of center lines was taken from each of the samples whose magnetic properties and groove shape had been determined. The section was embedded in a carbon mold and polished. The polished section was observed by using a SEM to determine the thickness of a forsterite coating film at the groove bottom.

In addition, for comparison, samples having a groove pattern (Nos. 43 and 44 in Table 2 below) that small-scale groove groups in which the grooves are not formed continuously in the sheet transverse direction are formed such that grooves adjacent to each other in the sheet transverse direction overlap each other on a projection plane in a direction perpendicular to the rolling direction were prepared. Samples having a groove pattern (Nos. 45 and 46 in Table 1 below) that grooves adjacent to each other in the sheet transverse direction are separated with each other were also prepared. The groove shapes and the magnetic properties of these samples were evaluated. In addition, sections of the central portions in the groove width direction was observed by using a SEM as described above to determine thicknesses of forsterite coating films at the groove bottoms.

The results are collectively given in Table 2. It was clarified that, in the case that b/a was within the range according to aspects of the present invention, a thick forsterite coating film was formed at the groove bottom, it was possible to prevent a deterioration in magnetic flux density while achieving a large effect of improving iron loss. In addition, it was clarified that, in the case that c was 0 mm or more and 50 mm or less, a thicker forsterite coating film was formed at the groove bottom and there was a larger effect of improving iron loss.

TABLE 1
Chemical Composition (mass %)

| C | Si | Mn | Al | N | Se | S | O |
|---|---|---|---|---|---|---|---|
| 0.08 | 3.4 | 0.1 | 0.0260 | 0.007 | 0.0110 | 0.003 | 0.0025 |

TABLE 2

| | | | Forsterite Coating | Iron Loss | | |
|---|---|---|---|---|---|---|
| No. | b/a | c [mm] | Film Thickness [μm] | W_{17/50} [W/kg] | B₈ [T] | Note |
| 1 | 0 | 0 | 2 | 0.710 | 1.930 | Comparative Example |
| 2 | 0.05 | 0 | 4 | 0.690 | 1.930 | Example |
| 3 | 0.1 | 0 | 4 | 0.685 | 1.930 | Example |
| 4 | 0.5 | 0 | 4 | 0.685 | 1.930 | Example |
| 5 | 0.9 | 0 | 4 | 0.685 | 1.930 | Example |
| 6 | 0.95 | 0 | 4 | 0.690 | 1.930 | Example |
| 7 | 1.0 | 0 | 2 | 0.690 | 1.920 | Comparative Example |
| 8 | 0 | 0.1 | 2 | 0.700 | 1.930 | Comparative Example |
| 9 | 0.05 | 0.1 | 4 | 0.685 | 1.930 | Example |
| 10 | 0.1 | 0.1 | 4 | 0.680 | 1.930 | Example |
| 11 | 0.5 | 0.1 | 4 | 0.680 | 1.930 | Example |
| 12 | 0.9 | 0.1 | 4 | 0.680 | 1.930 | Example |
| 13 | 0.95 | 0.1 | 4 | 0.685 | 1.930 | Example |
| 14 | 1.0 | 0.1 | 2 | 0.685 | 1.920 | Comparative Example |
| 15 | 0 | 10 | 2 | 0.700 | 1.930 | Comparative Example |
| 16 | 0.05 | 10 | 4 | 0.685 | 1.930 | Example |
| 17 | 0.1 | 10 | 4 | 0.680 | 1.930 | Example |
| 18 | 0.5 | 10 | 4 | 0.680 | 1.930 | Example |
| 19 | 0.9 | 10 | 4 | 0.680 | 1.930 | Example |
| 20 | 0.95 | 10 | 4 | 0.685 | 1.930 | Example |
| 21 | 1.0 | 10 | 2 | 0.685 | 1.920 | Comparative Example |
| 22 | 0 | 40 | 2 | 0.700 | 1.930 | Comparative Example |
| 23 | 0.05 | 40 | 4 | 0.685 | 1.930 | Example |
| 24 | 0.1 | 40 | 4 | 0.680 | 1.930 | Example |
| 25 | 0.5 | 40 | 4 | 0.680 | 1.930 | Example |
| 26 | 0.9 | 40 | 4 | 0.680 | 1.930 | Example |
| 27 | 0.95 | 40 | 4 | 0.685 | 1.930 | Example |
| 28 | 1.0 | 40 | 2 | 0.685 | 1.920 | Comparative Example |
| 29 | 0 | 50 | 2 | 0.710 | 1.930 | Comparative Example |
| 30 | 0.05 | 50 | 4 | 0.690 | 1.930 | Example |
| 31 | 0.1 | 50 | 4 | 0.685 | 1.930 | Example |
| 32 | 0.5 | 50 | 4 | 0.685 | 1.930 | Example |
| 33 | 0.9 | 50 | 4 | 0.685 | 1.930 | Example |
| 34 | 0.95 | 50 | 4 | 0.690 | 1.930 | Example |
| 35 | 1.0 | 50 | 2 | 0.690 | 1.920 | Comparative Example |
| 36 | 0 | 60 | 2 | 0.710 | 1.925 | Comparative Example |
| 37 | 0.05 | 60 | 3 | 0.695 | 1.925 | Example |
| 38 | 0.1 | 60 | 3 | 0.690 | 1.925 | Example |
| 39 | 0.5 | 60 | 3 | 0.690 | 1.925 | Example |
| 40 | 0.9 | 60 | 3 | 0.690 | 1.925 | Example |
| 41 | 0.95 | 60 | 3 | 0.695 | 1.925 | Example |
| 42 | 1.0 | 60 | 2 | 0.695 | 1.910 | Comparative Example |
| 43 | 1.2^{*1} | 10^{*2} | 2 | 0.695 | 1.920 | Comparative Example |
| 44 | 1.1^{*1} | 10^{*2} | 2 | 0.695 | 1.920 | Comparative Example |
| 45 | 0.1^{*1} | −0.5^{*3} | 2 | 0.730 | 1.930 | Comparative Example |
| 46 | 0.1^{*1} | −1^{*4} | 2 | 0.730 | 1.930 | Comparative Example |

underlined items indicate items out of the ranges of the present invention.
^{*1}(distance in the groove width direction between the center lines of the grooves adjacent to each other in the sheet transverse direction)/(groove width)
^{*2}lap length when the grooves adjacent to each other in the sheet transverse direction are projected on a projection plane in a direction perpendicular to the rolling direction
^{*3}It is indicated that a distance in the longitudinal direction of the grooves of 0.5 mm is provided between the edges of the grooves adjacent to each other in the sheet transverse direction.
^{*4}It is indicated that a distance in the longitudinal direction of the grooves of 1 mm is provided between the edges of the grooves adjacent to each other in the sheet transverse direction.

### REFERENCE SIGNS LIST

1 linear groove

2 discontinuous portion of center lines

1. A grain-oriented electrical steel sheet comprising:
linear grooves formed cyclically in a rolling direction of the grain-oriented electrical steel sheet such that a longitudinal direction of the linear grooves intersects the rolling direction, wherein:
each of the linear grooves has a discontinuous portion of center lines where center lines of the groove are shifted in a groove width direction, and
when a width of the linear groove is defined as a and a distance in the groove width direction between the center lines in the discontinuous portion of center lines is defined as b,
a and b satisfy relational expression (1) below:
0.05≤b/a≤0.95 (1).

2. The grain-oriented electrical steel sheet according to claim 1, wherein a length in the longitudinal direction of the linear groove of the discontinuous portion of center lines is 0 mm or more and 50 mm or less.
